(19) United States
(12) Patent Application Publication
(10) Pub. No.: US 2018/0082153 A1
(43) Pub. Date: Mar. 22, 2018

(54) SYSTEMS AND METHODS FOR DECONVOLUTIONAL NETWORK BASED CLASSIFICATION OF CELLULAR IMAGES AND VIDEOS

(71) Applicant: Siemens Aktiengesellschaft, Munich (DE)

(72) Inventors: Shaohua Wan, Beijing (CN); Shanhui Sun, Princeton, NJ (US); Terrence Chen, Princeton, NJ (US); Bogdan Georgescu, Plainsboro, NJ (US); Ali Kamen, Skillman, NJ (US)

(21) Appl. No.: 15/554,557

(22) PCT Filed: Mar. 11, 2015
(86) PCT No.: PCT/US2015/019844

§ 371 Date: Aug. 30, 2017

(51) Int. Cl. G06K 9/62; G06T 7/00; G06K 9/00

(52) U.S. Cl. CPC G06K 9/6259; G06T 7/0014; G06K 9/00147; G06K 9/00134; G06T 2207/30096; G06T 2207/10056; G06T 2207/10016; G06T 2207/30016; G06K 9/6249

(57) ABSTRACT

A method for performing cellular classification includes using a convolution sparse coding process to generate a plurality of feature maps based on a set of input images and a plurality of biologically-specific filters. A feature pooling operation is applied on each of the plurality of feature maps to yield a plurality of image representations. Each image representation is classified as one of a plurality of cell types.

### TECHNICAL FIELD

The present disclosure relates generally to methods, systems, and apparatuses for performing for a deconvolutional network based classification of cellular images and videos. The proposed technology may be applied, for example, to a variety of cellular image classification tasks.

### BACKGROUND

In-vivo cell imaging is the study of living cells using images acquired from imaging systems such as endomicroscopes. Due to recent advances in fluorescent protein and synthetic fluorophore technology, an increasing amount of research efforts are being devoted to in-vivo cell imaging techniques that provide insight into the fundamental nature of cellular and tissue function. In-vivo cell imaging technologies now span multiple modalities, including, for example, multi-photon, spinning disk microscopy, fluorescence, phase contrast, and differential interference contrast, and laser scanning confocal-based devices.

Additionally, there has been a growing interest in employing computer-aided image analysis techniques for various routine clinical pathology tests. With the ever increasing amount of microscopy imaging data that is stored and processed digitally, one challenge is to categorize these images and make sense out of them reliably during medical procedures. Results obtained by these techniques are used to support clinicians' manual/subjective analysis, leading to test results that are more reliable and consistent. To this end, in order to address the shortcomings of the manual test procedure, one could use Computer Aided Diagnostic (CAD) systems and methods which automatically determine the patterns in the given in-vivo cell images. The state-of-the-art image recognition systems rely on human-designed features such as Scale Invariant Feature Transform (SIFT), Local Binary Pattern (LBP), Histogram of Oriented Gradient (HOG), and Gabor features. Although human-designed features provide state-of-the-art performance on a number of benchmark datasets, the application of these is limited due to the manual nature of their engineering.

Recently, unsupervised feature learning has been shown to outperform human-designed features for a variety of image recognition tasks. For cellular image recognition, unsupervised learning offers the potential of learning features that are rooted in the biological reasoning of the object/image recognition process. Accordingly, it is desired to provide systems and methods for cellular classification which use unsupervised learning techniques to address the limitations of current classification systems which utilize human-designed features in their analysis.

### SUMMARY

Embodiments of the present invention address and overcome one or more of the above shortcomings and drawbacks, by providing methods, systems, and apparatuses related to a deconvolutional network based classification of cellular images and videos. Briefly, cellular images are classified using an unsupervised feature learning method that learns biologically-specific filters and discriminative feature maps, as well as a concatenation of three processing units that generate the final image representation given the feature maps of the images. The various embodiments discussed herein may be used to increase the recognition accuracy of cellular image. The examples provided herein are directed at brain tumor endomicroscopy images. However, it should be understood that the techniques described herein may be applied similarly to the classification of other types of medical images, or even natural images.

According to some embodiments, a method for performing cellular classification includes using a convolution sparse coding process to generate a plurality of feature maps based on a set of input images and a plurality of biologically-specific filters. A feature pooling operation is applied on each of the feature maps to yield a plurality of image representations. Each image representation is classified as one of a plurality of cell types. In some embodiments, an element-wise absolute value function may be applied to the feature maps. In one embodiment, application of the element-wise absolute function is followed by a local contrast normalization which may comprise, for example, applying a local subtractive operation and a divisive operation to each of the feature maps. In embodiments where the set of input images comprises a video stream, each image representation may be classified using majority voting within a time window having a predetermined length.

In one embodiment of the aforementioned method, input images are acquired, for example, using an endomicroscopy device or a digital holographic microscopy device during a medical procedure. An entropy value is calculated for each of input images. Each entropy value is representative of an amount of texture information in a respective image. One or more low-entropy images (e.g., images with entropy values below a threshold value) are identified in the set of input images. Next, the set of input images is generated based on the input images and excludes the low-entropy images.

In some embodiments of the aforementioned method, an unsupervised learning process is used to determine the biologically-specific filters based on a plurality of training images. For example, in one embodiment, the unsupervised learning process iteratively applies a cost function to solve for the biologically-specific filters and an optimal set of feature maps that reconstruct each of the plurality of training images. The cost function may be solved, for example, using an alternating projection method.

According to other embodiments, a second method for performing cellular classification during a medical procedure includes features performed prior to and during the medical procedure. Prior to the medical procedure, an unsupervised learning process is used to determine biologically-specific filters based on training images. During the medical procedure, a cell classification process is performed. This process may include acquiring an input image using an endomicroscopy device and using a convolution sparse coding process to generate a feature map based on the input image and the biologically-specific filters. A feature pooling operation is applied on the feature map to yield an image representation and a trained classifier is used to identify a class label corresponding to the image representation. This class label may provide, for example, an indication of whether biological material in the input image is malignant, benign, or healthy tissue. Once the class label is identified, it may be presented on a display operably coupled to the endomicroscopy device.

Various features may be added, modified, and/or refined in the aforementioned second method. For example, in some embodiments, an element-wise absolute value function is applied to the feature map prior to applying the feature pooling operation. In some embodiments, a local contrast normalization is applied to the feature map prior to applying the feature pooling operation. This local contrast normalization may comprise, for example, the application of a local subtractive operation and a divisive operation to the feature map.

According to other embodiments, a system performing cellular classification includes a microscopy device, an imaging computer, and a display. The microscopy device is configured to acquire a set of input images during a medical procedure. This device may comprise, for example, a Confocal Laser Endo-microscopy device or a Digital Holographic Microscopy device. The imaging computer is configured to perform a cellular classification process during the medical procedure. This cellular classification process may include using a convolution sparse coding process to generate feature maps based on the set of input images and biologically-specific filters and applying a feature pooling operation on each of the feature maps to yield image representations which, in turn, may be used in identifying cellular class labels corresponding to the set of input images. In some embodiments, the cellular classification process further includes applying an element-wise absolute value function and a local contrast normalization to each of the feature maps prior to applying the feature pooling operation. The display included in the system is configured to present the one cellular class labels during the medical procedure.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an example of a endomicroscopy-based system which may be used to perform cell classification, according to some embodiments;

FIG. 2 provides an overview of a Cell Classification Process that may be applied in some embodiments of the present invention;

FIG. 3 provides a set of low-entropy and high-entropy images of Glioblastoma and Meningioma;

FIG. 4 provides an example of image entropy distribution for images in a brain tumor dataset, as may be utilized in some embodiments;

FIG. 5 provides an example of an alternating projection method that may be used during filter learning, according to some embodiments;

FIG. 6 provides an example of learned filters generated using set of Glioblastoma images and Meningioma images as training images, according to some embodiments;

FIG. 7 provides an example of feature map extraction, as may be performed using some of the techniques discussed herein; and

FIG. 8 illustrates an exemplary computing environment, within which embodiments of the invention may be implemented.

### DETAILED DESCRIPTION OF ILLUSTRATIVE EMBODIMENTS

The following disclosure includes several embodiments directed at methods, systems, and apparatuses related to a cellular online image classification system which utilizes an unsupervised feature learning model based on Deconvolutional Networks. As is understood in the art, Deconvolutional Networks is an unsupervised learning framework based on the convolutional decomposition of images. Deconvolutional Networks offer the ability to learn biologically-relevant features from input images and the learned features are invariant to translation due to its convolutional reconstruction nature of the framework. The various systems, methods, and apparatuses for cellular classification are described with reference to two cellular imaging modalities: Confocal Laser Endo-microscopy (CLE) and Digital Holographic Microscopy (DHM). However, it should be understood that the various embodiments of this disclosure are not limited to these modalities and may be applied in a variety of clinical settings. Additionally, it should be understood that the techniques described herein may be applied to the classification of various types of medical images, or even natural images.

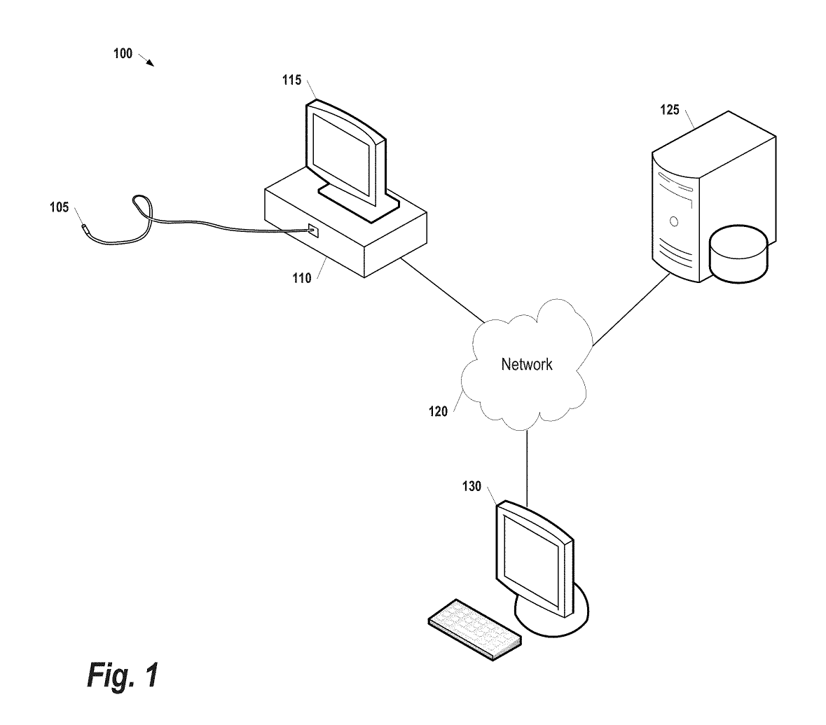

FIG. 1 provides an example of an endomicroscopy-based system 100 which may be used to perform cell classification, according to some embodiments. Briefly, endomicroscopy is a technique for obtaining histology-like images from inside the human body in real-time through a process known as “optical biopsy.” The term “endomicroscopy” generally refers to fluorescence confocal microscopy, although multi-photon microscopy and optical coherence tomography have also been adapted for endoscopic use and may be likewise used in various embodiments. Non-limiting examples of commercially available clinical endomicroscopes include the Pentax ISC-1000/EC3870CIK and Cellvizio (Mauna Kea Technologies, Paris, France). The main applications have traditionally been in imaging the gastro-intestinal tract, particularly for the diagnosis and characterization of Barrett's Esophagus, pancreatic cysts and colorectal lesions. The diagnostic spectrum of confocal endomicroscopy has recently expanded from screening and surveillance for colorectal cancer towards Barrett's esophagus, Helicobacter pylori associated gastritis and early gastric cancer. Endomicroscopy enables subsurface analysis of the gut mucosa and in vivo histology during ongoing endoscopy in full resolution by point scanning laser fluorescence analysis. Cellular, vascular and connective structures can be seen in detail. The new detailed images seen with confocal laser endomicroscopy will allow a unique look on cellular structures and functions at and below the surface of the gut. Additionally, as discussed in further detail below, endomicroscopy may also be applied brain surgery where identification of malignant (glioblastoma) and benign (meningioma) tumors from normal tissues is clinically important.

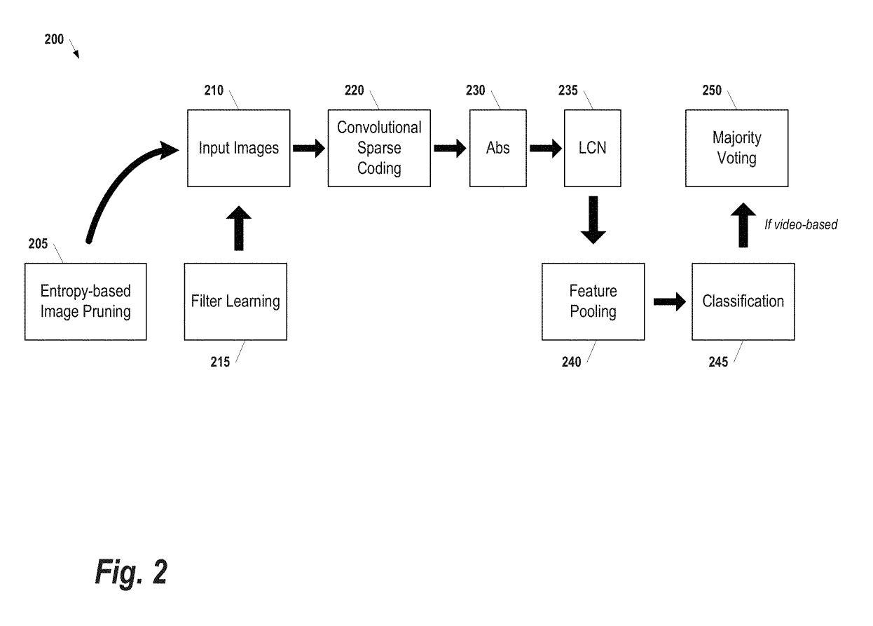

In the example of FIG. 1, a group of devices are configured to perform Confocal Laser Endo-microscopy (CLE). These devices include a Probe 105 operably coupled to an Imaging Computer 110 and an Imaging Display 115. In FIG. 1, Probe 105 is a confocal miniature probe. However, it should be noted that various types of miniature probes may be used, including probes designed for imaging various fields of view, imaging depths, distal tip diameters, and lateral and axial resolutions. The Imaging Computer 110 provides an excitation light or laser source used by the Probe 105 during imaging. Additionally, the Imaging Computer 110 may include imaging software to perform tasks such as recording, reconstructing, modifying, and/or export images gathered by the Probe 105. The Imaging Computer 110 may also be configured to perform a Cell Classification Process, discussed in greater detail below with respect to FIG. 2.

A foot pedal (not shown in FIG. 1) may also be connected to the Imaging Computer 110 to allow the user to perform functions such as, for example, adjusting the depth of confocal imaging penetration, start and stop image acquisition, and/or saving image either to a local hard drive or to a remote database such as Database Server 125. Alternatively or additionally, other input devices (e.g., computer, mouse, etc.) may be connected to the Imaging Computer 110 to perform these functions. The Imaging Display 115 receives images captured by the Probe 105 via the Imaging Computer 110 and presents those images for view in the clinical setting.

Continuing with the example of FIG. 1, the Imaging Computer 110 is connected (either directly or indirectly) to a Network 120. The Network 120 may comprise any computer network known in the art including, without limitation, an intranet or internet. Through the Network 120, the Imaging Computer 110 can store images, videos, or other related data on a remote Database Server 125. Additionally a User Computer 130 can communicate with the Imaging Computer 110 or the Database Server 125 to retrieve data (e.g., images, videos, or other related data) which can then be processed locally at the User Computer 130. For example, the User Computer 130 may retrieve data from either Imaging Computer 110 or the Database Server 125 and use it to perform the Cell Classification Process discussed below in FIG. 2.

Although FIG. 1 shows a CLE-based system, in other embodiments, the system may alternatively use a DHM imaging device. DHM, also known as interference phase microscopy, is an imaging technology that provides the ability to quantitatively track sub-nanometric optical thickness changes in transparent specimens. Unlike traditional digital microscopy, in which only intensity (amplitude) information about a specimen is captured, DHM captures both phase and intensity. The phase information, captured as a hologram, can be used to reconstruct extended morphological information (e.g., depth and surface characteristics) about the specimen using a computer algorithm. Modern DHM implementations offer several additional benefits, such as fast scanning/data acquisition speed, low noise, high resolution and the potential for label-free sample acquisition. While DHM was first described in the 1960s, instrument size, complexity of operation and cost have been major barriers to widespread adoption of this technology for clinical or point-of-care applications. Recent developments have attempted to address these barriers while enhancing key features, raising the possibility that DHM could be an attractive option as a core, multiple impact technology in healthcare and beyond.

The ability of DHM to achieve high-resolution, wide field imaging with extended depth and morphological information in a potentially label-free manner positions the technology for use in several clinical applications, including: hematology (e.g., RBC volume measurement, white blood cell differential, cell type classification), urine sediment analysis (e.g., scanning a microfluidic sample in layers to reconstruct the sediment and improving the classification accuracy of sediment constituents); tissue pathology (e.g., utilization of extended morphology/contrast of DHM to discriminate cancerous from healthy cells, in fresh tissue, without labeling); and rare cell detection (e.g., utilizing extended morphology/contrast of DHM to differentiate rare cells such as circulating tumor/epithelial cells, stem cells, infected cells, etc.). Given the latest advancements DHM technology—particularly reductions in size, complexity and cost—these and other applications (including the Cell Classification Process described below in FIG. 2) can be performed within a clinical environment or at the point of care in a decentralized manner.

FIG. 2 provides an overview of a Cell Classification Process 200 that may be applied in some embodiments of the present invention. This process 200 is illustrated as a pipeline of comprising three parts: offline unsupervised filter learning, offline supervised classifier training, and online image and video classification. The core components of the process 100 are filter learning, convolutional sparse coding, feature pooling, and classification. Briefly, biologically-specific filters are learned from one or more training images. One or more image frames are received, either directly or indirectly, from a biological imaging device (see FIG. 1). Then, convolutional sparse coding is applied to decompose the learned filters as a sum of a set of sparse feature maps for the images convolved with the learned filters. These feature maps are then processed by three layers: an element-wise absolute value rectification (Abs), local contrast normalization (LCN), and feature-pooling (FP). Finally, a classifier is applied to the resulting features to identify one or more class labels for the data based on pre-determined cellular data. These class labels may provide an indication of, for example, whether a particular tissue is malignant or benign. Additionally, in some embodiments, the class label may provide an indication of healthy tissue. Various components for performing the Cell Classification Process 200 are described in greater detail below, along with some additional optional features which may be applied in some embodiments.

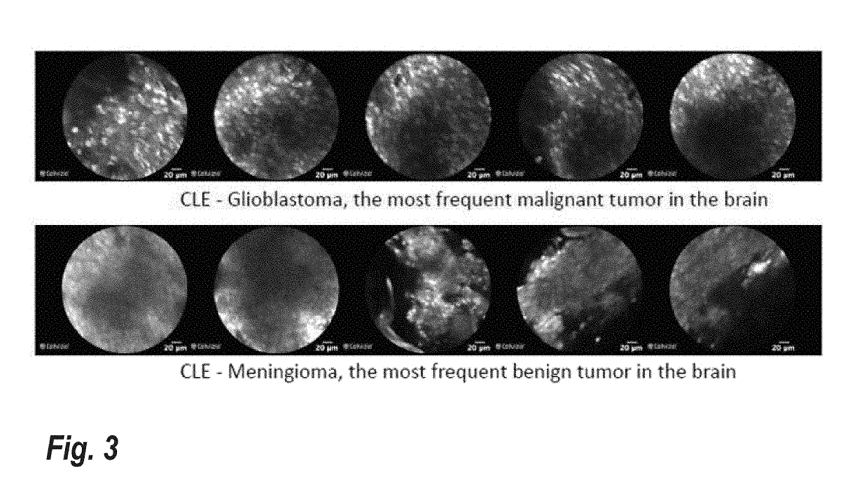

Prior to the start of the Cell Classification Process 200, an Entropy-based Image Pruning Component 205 may optionally be used to automatically remove image frames with low image texture information (e.g., low-contrast and contain little categorical information) that may not be clinically interesting or not suitable for image classification. This removal may be used, for example, to address the limited imaging capability of some CLE devices. Image entropy is a quantity which is used to describe the “informativeness” of an image, i.e., the amount of information contained in an image. Low-entropy images have very little contrast and large runs of pixels with the same or similar gray values. On the other hand, high entropy images have a great deal of contrast from one pixel to the next. FIG. 3 provides a set of low-entropy and high-entropy images of Glioblastoma and Meningioma. As shown in the figure, low-entropy images contain a lot of homogeneous image regions, while high-entropy images are characterized by rich image structures.

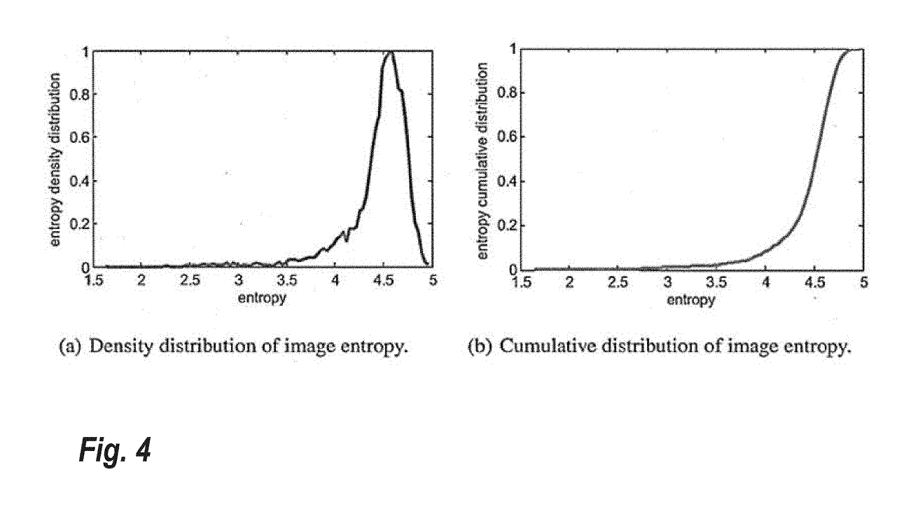

In some embodiments, the Entropy-based Image Pruning Component 205 performs pruning using an entropy threshold. This threshold may be set based on the distribution of the image entropy throughout the dataset. FIG. 4 provides an example of image entropy distribution for images in a brain tumor dataset, as may be utilized in some embodiments. As can be seen, there is a relatively large number of images whose entropy is significantly lower than that of the rest of the images. Thus, for this example, the entropy threshold can be set such that 10% of images will be discarded from later stages of our system (e.g., 4.05 for data shown in FIG. 4).

Continuing with reference to FIG. 2, a Filter Learning Component 215 is configured to learn biologically-specific filters from training images. Various techniques may be used in learning the filters. For example, in some embodiments, an optimization problem is iteratively solved to determine the filters. Let X={xᵢ}ᵢ₌₁^{N} be a set of 2D images, where xᵢ∈ [symbol] ^{m×n} and F={ƒₖ}ₖ₌₁^{N} be a set of convolutional filters, where ƒₖ∈ [symbol] ^{w×w}. For each image xᵢ, let Zⁱ={zₖⁱ}ₖ₌₁^{K} be a set of feature maps where zₖⁱ has a dimension (m+w−1)×(n+w−1). During training, the Filter Learning Component 215 aims to solve for the optimal set of filters and feature maps that reconstruct each training image. In some embodiments, these calculations are quantified by the following equations:

$$\begin{matrix}arg {min}_{F , Z} ℒ ( F , Z ) = {\sum }_{i = 1}^{N} {‖ {x}_{i} - {\sum }_{k = 1}^{K} {f}_{k} * {z}_{k}^{i} ‖}_{2}^{2} + λ {\sum }_{i = 1}^{K} {‖ {z}_{k}^{i} ‖}_{1} & ( 1 ) \\ s . t . {‖ {f}_{k} ‖}_{2}^{2} = 1 , ∀ k = 1 , … , K & ( 2 )\end{matrix}$$

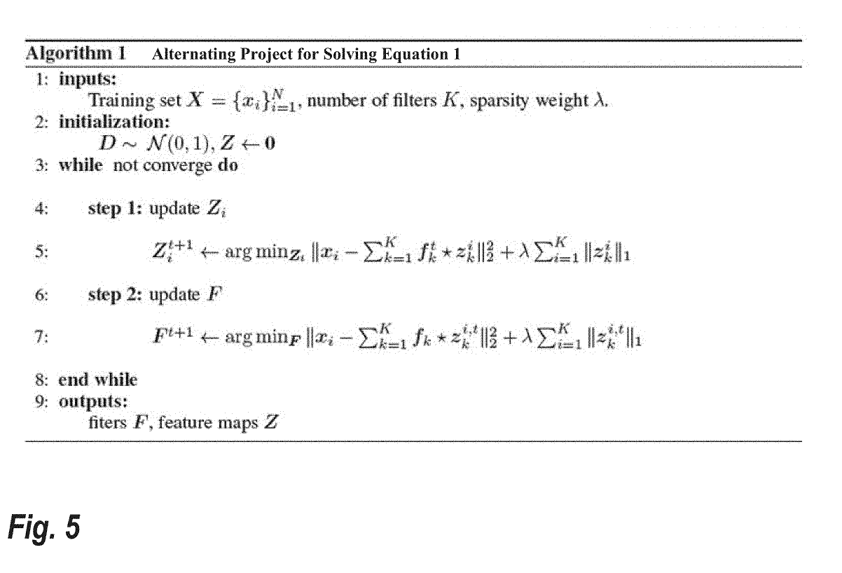

The first term in Equation 1 denotes the image reconstruction error and the second term denotes the sparsity regularization imposed on the feature maps. In this equation, ∥·∥₁ is L1 norm and ∥·∥₂ is L2 norm. The star * denotes the 2D discrete convolution operator. The parameter λ is the weight parameter for the sparsity regularization term. The unit energy constraint (Equation 2) may be imposed on the filters to avoid trivial solutions. In some embodiments, Equation 1 may be solved with an Alternating Projection method, alternately minimizing [symbol] (F, Z) over the feature maps while keeping the filters fixed and then minimizing [symbol] (F, Z) over the filters while keeping the feature maps fixed. Although the objective Equation 1 is not jointly convex with respect to F and Z, it is convex with respect to each one of them when the other is fixed. Thus, convergence of the algorithm is guaranteed. An example implementation of the algorithm is given in FIG. 5.

It should be noted that the technique discussed above for learning the filters is only one example of how the filters may be determined. This technique may be varied in different embodiments. For example, optimization algorithms other than Alternating Projection may be used in solving the equation (e.g., Alternating Direction Method of Multipliers or Fast Iterative Shrinkage Thresholding Algorithm) or different learning techniques may be employed (e.g., neural networks). Additionally (or alternatively), equations other than those discussed above may be used in the filter calculation.

The Convolutional Sparse Coding Component 220 utilizes the learned filters from the Filter Learning Component 215 and decomposes them as the sum of a set of sparse feature maps for the Input Images 210 convolved with the learned filters. Using the notation discussed above with respect to Equation 1, these feature maps are referred to herein as {zₖⁱ}. Convolutional sparse coding is a technique generally known in the art which is designed to model shift invariance directly in order to overcome the scalability issues of applying sparse coding techniques to large images. The objective for convolutional sparse coding may be represented as follows:

$$arg {min}_{Z} {‖ {x}_{i} - {\sum }_{k = 1}^{K} {f}_{k} * {z}_{k}^{i} ‖}_{2}^{2} + λ {\sum }_{i = 1}^{K} {‖ {z}_{k}^{i} ‖}_{1} \qquad ( 3 )$$

Equation 3 may be solved using an optimization equation, similar to the solving of Equation (1) as discussed above. Thus, for example, techniques such as FISTA or Alternating Direction Method of Multipliers may be employed.

After the Convolutional Sparse Coding Component 220 completes its processing, the feature maps {zₖⁱ} are processed by three layers: an element-wise absolute value rectification (Abs), local contrast normalization (LCN), and feature-pooling (FP). The Abs Component 230 shown in FIG. 2 computes absolute value element-wise in each feature map to avoid the cancelation effect in subsequent operations. The LCN Component 235 enhances stronger feature responses and suppresses weaker ones across the feature maps {zₖⁱ} by performing local subtractive and divisive operations. The local subtractive operation for a given location z_{i,p q}^{k} (wherein p and q are pixel indices in x and y direction on the feature map zᵢ^{k}) may be determined, for example, as follows:

$${z}_{k , p , q}^{i} ← {z}_{k , p , q}^{i} - {\sum }_{Δ p , Δ q} {ω}_{Δ p Δ q} {z}_{k , p + Δ p , q + Δ q}^{i} \qquad ( 4 )$$

In Equation 4, w_{ΔpΔq} is a weighting function normalized so that Σ_{ΔpΔq}w_{ΔpΔq}=1 and ΔpΔq are the pixel index in x and y direction. The local divisive operation may be performed according to the following equation:

$${z}_{k , p , q}^{i} ← {z}_{k , p , q}^{i} / {( {\sum }_{Δ p , Δ q} {ω}_{Δ p Δ q} {z}_{k , p + Δ p , q + Δ q}^{i} )}^{0.5} \qquad ( 4 )$$

A Feature Pooling Component 240 applies one or more feature pooling operations to summarize the feature maps to generate the final image representation. The Feature Pooling Component 240 may apply any pooling technique known in the art including, for example, max-pooling, average-pooling, or a combination thereof. For example, in some embodiments, the Feature Pooling Component 240 uses a composition of max-pooling and average-pooling operations. For example, each feature map may be partitioned into regularly spaced square patches and a max-polling operation may be applied (i.e., the maximum response for the feature over each square patch may be determined). The max-pooling operation allows local invariance to translation. Then, the average of the maximum response may be calculated from the square patches, i.e. average pooling is applied after max-pooling. Finally, the image representation may be formed by aggregating feature responses from the average-pooling operation.

The Classification Component 245 identifies one or more class labels for the final image representation based on one or more pre-defined criteria. These class labels may provide an indication of, for example, whether a particular tissue is malignant or benign. Additionally, in some embodiments, the class labels may provide an indication of healthy tissue. The Classification Component 245 utilizes one or more classifier algorithms which may be trained and configured based on the clinical study. For example, in some embodiments, the classifier is trained using a brain tumor dataset, such that it can label images as either glioblastoma or meningioma. Various types of classifier algorithms may be used by the Classification Component 245 including, without limitation, support vector machines (SVM), k-nearest neighbors (k-NN), and random forests. Additionally, different types of classifiers can be used in combination.

For video image sequences, a Majority Voting Component 250 may optionally perform a majority voting based classification scheme that boosts the recognition performance for the video stream. Thus, if input images are video-stream based, the process 200 is able to incorporate the visual cues from adjacent images. The Majority Voting Component 250 assigns class labels to the current image using the majority voting result of the images within a fixed length time window surrounding the current frame in a causal fashion. The length of the window may be configured based on user input. For example, the user may provide a specific length value or clinical settings which may be used to derive such a value. Alternatively, the length may be dynamically adjusted over time based on an analysis of past results. For example, if the user indicates that the Majority Voting Component 250 is providing inadequate or sub-optimal results, the window may be adjusted by modifying the window size by a small value. Over time, the Majority Voting Component 250 can learn an optimal window length for each type of data being processed by the Cell Classification Process 200. In some embodiments, the window length may also depend on the frame rate.

As an example application of the Cell Classification Process 200, consider a dataset of endomicroscopic videos collected using a CLE Device (see FIG. 1) that is inserted inside the patients' brain for examining brain tumor tissues. This collection may result in a set of videos for Glioblastoma and a set of videos for Meningioma. One example of the images collected in such videos is provided in FIG. 3. Notice that some frames with low image texture information are not clinically interesting or not discriminative for image classification. Image entropy may be used to measure the “informativeness” of an image region (i.e., the amount of information contained in an image). Those images with image entropy values which are lower than a predefined threshold may be excluded from the evaluation.

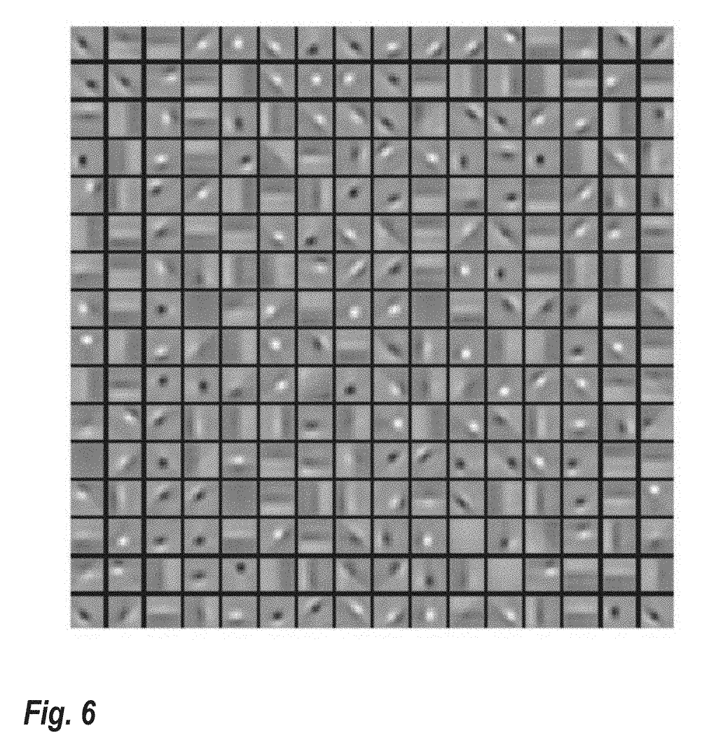

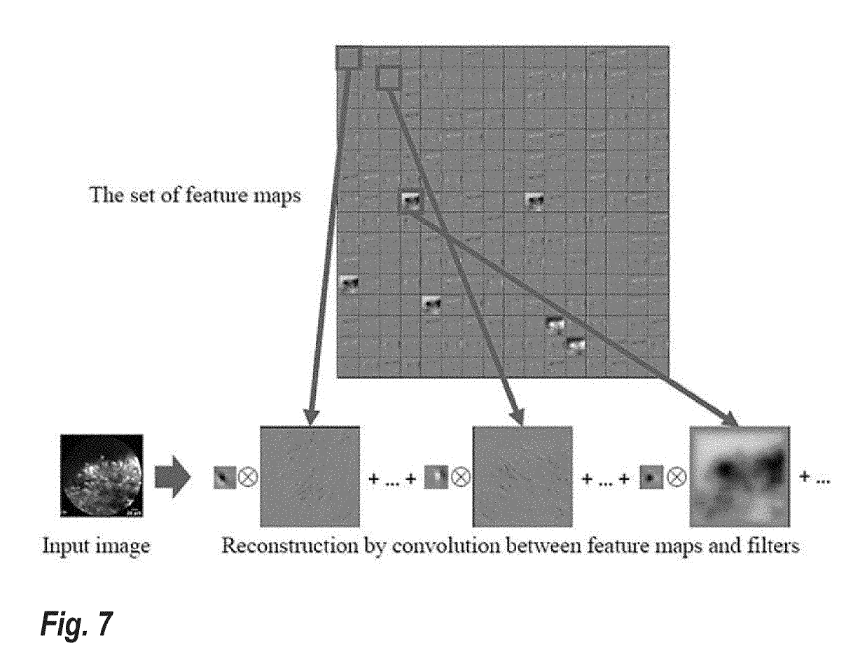

Continuing with this example, the Alternating Projection algorithm (see FIG. 5) may be used to learn a set of biological component-specific filters. A large set of Glioblastoma images and Meningioma images may be used as training images. FIG. 6 provides an example of learned filters generated using such data. As can be seen in FIG. 6, the filters are characterized by dots and edges that resemble the granular and texture patterns in the Glioblastoma and Meningioma images. Convolutional sparse coding is then applied to decompose the learned filters as a sum of a set of sparse feature maps convolved with the learned filters. FIG. 7 provides an example of feature map extraction, as may be performed using some of the techniques discussed herein. The top figure is a set of feature maps for an example input image. The entries in the feature maps of the given Glioblastoma image are mostly zero. The resemblance between filters and the image patterns, and the sparsity of the feature maps jointly make our feature representation more discriminative than conventional hand-designed feature representations.

Another application of the Cell Classification Process 200 is to perform an online video classification. Thus, it may not be necessary to acquire the whole video sequence first and then do the classification.

To evaluate the performance of the techniques discussed herein, an analysis was performed using the leave-one-video-out approach. More specifically, as a first step, 10 Glioblastoma and 10 Meningioma sequences were randomly selected. Next, as a second step, one pair of sequences from that first set were selected for testing and the remaining sequences for training, Then, as a third step, 4000 Glioblastoma frames and 4000 Meningioma frames are selected from the training sets. The second and third steps were repeated 5 rounds and average was calculated. For each image, its feature maps are calculated by minimizing the objective in Equation 3. The feature maps were then processed by Abs, LCN, and feature-pooling techniques (discussed above with respect to FIG. 2) to generate the final image. Then, a SVM classifier was utilized to provide the final classification of the image. This analysis was performed with a set of different pooling parameters, demonstrating that the max-pooling with spacing of 10 pixels and patch size of 30 pixels provide a good recognition performance, as shown in the following table providing the recognition accuracy on the brain tumor dataset discussed above:

| Accuracy | Sensitivity | Specificity |
|---|---|---|
| 0.8758 | 0.841 | 0.92 |

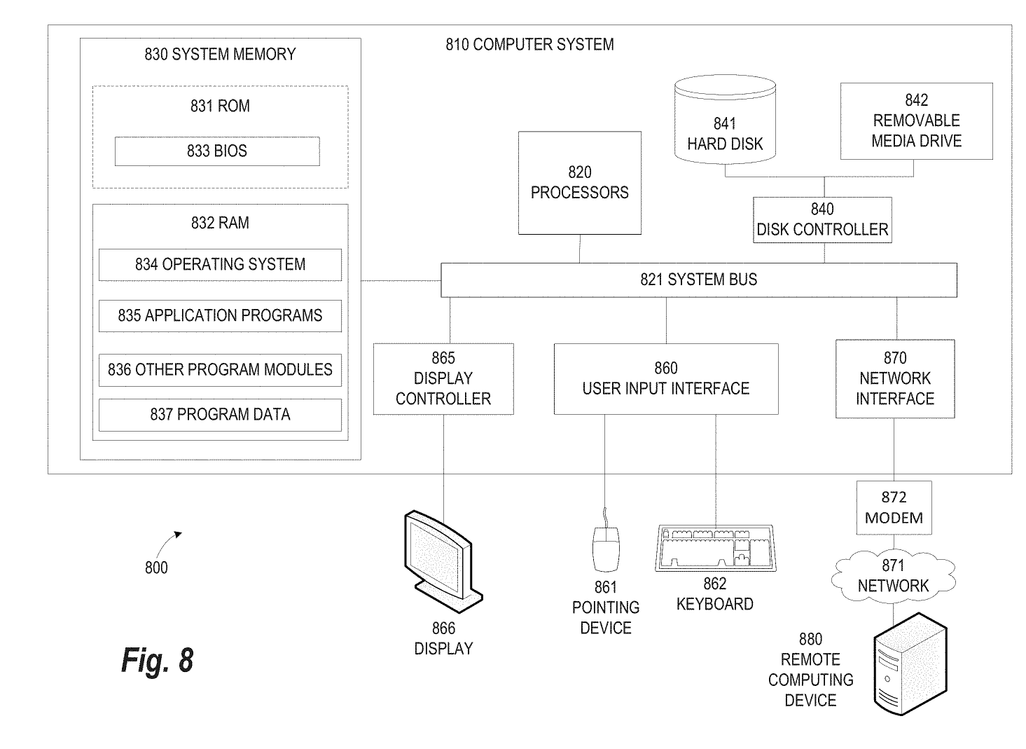

FIG. 8 illustrates an exemplary computing environment 800 within which embodiments of the invention may be implemented. For example, this computing environment 800 may be used to implement one or more of devices shown in FIG. 1 and execute the Cell Classification Process 200 described in FIG. 2. The computing environment 800 may include computer system 810, which is one example of a computing system upon which embodiments of the invention may be implemented. Computers and computing environments, such as computer system 810 and computing environment 800, are known to those of skill in the art and thus are described briefly here.

As shown in FIG. 8, the computer system 810 may include a communication mechanism such as a bus 821 or other communication mechanism for communicating information within the computer system 810. The computer system 810 further includes one or more processors 820 coupled with the bus 821 for processing the information. The processors 820 may include one or more central processing units (CPUs), graphical processing units (GPUs), or any other processor known in the art.

The computer system 810 also includes a system memory 830 coupled to the bus 821 for storing information and instructions to be executed by processors 820. The system memory 830 may include computer readable storage media in the form of volatile and/or nonvolatile memory, such as read only memory (ROM) 831 and/or random access memory (RAM) 832. The system memory RAM 832 may include other dynamic storage device(s) (e.g., dynamic RAM, static RAM, and synchronous DRAM). The system memory ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in ROM 831. RAM 832 may contain data and/or program modules that are immediately accessible to and/or presently being operated on by the processors 820. System memory 830 may additionally include, for example, operating system 834, application programs 835, other program modules 836 and program data 837.

The computer system 810 also includes a disk controller 840 coupled to the bus 821 to control one or more storage devices for storing information and instructions, such as a hard disk 841 and a removable media drive 842 (e.g., floppy disk drive, compact disc drive, tape drive, and/or solid state drive). The storage devices may be added to the computer system 810 using an appropriate device interface (e.g., a small computer system interface (SCSI), integrated device electronics (IDE), Universal Serial Bus (USB), or FireWire).

The computer system 810 may also include a display controller 865 coupled to the bus 821 to control a display 866, such as a cathode ray tube (CRT) or liquid crystal display (LCD), for displaying information to a computer user. The computer system includes an input interface 860 and one or more input devices, such as a keyboard 862 and a pointing device 861, for interacting with a computer user and providing information to the processor 820. The pointing device 861, for example, may be a mouse, a trackball, or a pointing stick for communicating direction information and command selections to the processor 820 and for controlling cursor movement on the display 866. The display 866 may provide a touch screen interface which allows input to supplement or replace the communication of direction information and command selections by the pointing device 861.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium, such as a hard disk 841 or a removable media drive 842. The hard disk 841 may contain one or more datastores and data files used by embodiments of the present invention. Datastore contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processor 820 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 841 or removable media drive 842. Non-limiting examples of volatile media include dynamic memory, such as system memory 830. Non-limiting examples of transmission media include coaxial cables, copper wire, and fiber optics, including the wires that make up the bus 821. Transmission media may also take the form of acoustic or light waves, such as those generated during radio wave and infrared data communications.

The computing environment 800 may further include the computer system 810 operating in a networked environment using logical connections to one or more remote computers, such as remote computer 880. Remote computer 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computer 880). The network 871 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A method for performing cellular classification, the method comprising:
using a convolution sparse coding process to generate a plurality of feature maps based on a set of input images and a plurality of biologically-specific filters;
generating a plurality of image representations corresponding to the plurality of feature maps by (i) applying an element-wise absolute value function to each of the plurality of feature maps, (ii) applying a local contrast normalization to each of the plurality of feature maps, and (iii) applying a feature pooling operation on each of the plurality of feature maps to yield the plurality of image representations; and
classifying each image representation as one of a plurality of cell types.

2. The method of claim 1, further comprising:
acquiring a plurality of input images;
calculating an entropy value for each of the plurality of input images, each entropy value representative of an amount of texture information in a respective image;
identifying one or more low-entropy images in the plurality of input images, wherein the one or more low-entropy images are each associated with a respective entropy value below a threshold value; and
generating the set of input images based on the plurality of input images, wherein the set of input images excludes the one or more low-entropy images.

3. The method of claim 2, wherein the plurality of input images are acquired using an endomicroscopy device during a medical procedure.

4. The method of claim 2, wherein the plurality of input images are acquired using a digital holographic microscopy device during a medical procedure.

5. The method of claim 1, further comprising:
using an unsupervised learning process to determine the plurality of biologically-specific filters based on a plurality of training images.

6. The method of claim 5, wherein the unsupervised learning process iteratively applies a cost function to solve for the plurality of biologically-specific filters and an optimal set of feature maps that reconstruct each of the plurality of training images.

7. The method of claim 6, wherein the cost function is solved using an alternating projection method.

8. (canceled)

9. (canceled)

10. The method of claim 1, wherein the local contrast normalization comprises applying a local subtractive operation and a divisive operation to each of the plurality of feature maps.

11. The method of claim 1, wherein the set of input images comprises a video stream and each image representation is classified using majority voting within a time window having a predetermined length.

12. A method for performing cellular classification during a medical procedure, the method comprising:
prior to the medical procedure, using an unsupervised learning process to determine a plurality of biologically-specific filters based on a plurality of training images; and
during the medical procedure, performing a cell classification process comprising:
acquiring an input image using an endomicroscopy device,
using a convolution sparse coding process to generate a feature map based on the input image and the plurality of biologically-specific filters,
generating an image representation corresponding to the feature map by (i) applying an element-wise absolute value function to the feature map, (ii) applying a local contrast normalization to the feature map, and (iii) applying a feature pooling operation on the feature map to yield the image representation,
using a trained classifier to identify a class label corresponding to the image representation, and
presenting the class label on a display operably coupled to the endomicroscopy device.

13. (canceled)

14. (canceled)

15. The method of claim 12, wherein the local contrast normalization comprises applying a local subtractive operation and a divisive operation to the feature map.

16. The method of claim 12, wherein the class label provides an indication of whether biological material in the input image is malignant or benign.

17. A system performing cellular classification, the system comprising:
a microscopy device configured to acquire a set of input images during a medical procedure;
an imaging computer configured to perform a cellular classification process during the medical procedure, the cellular classification process comprising:
using a convolution sparse coding process to generate a plurality of feature maps based on the set of input images and a plurality of biologically-specific filters;
generating a plurality of image representations corresponding to the plurality of feature maps by (i) applying an element-wise absolute value function to each of the plurality of feature maps, (ii) applying a local contrast normalization to each of the plurality of feature maps, and (iii) applying a feature pooling operation on each of the plurality of feature maps to yield the plurality of image representations, and
identifying one or more cellular class labels corresponding to the set of input images; and
a display configured to present the one or more cellular class labels during the medical procedure.

18. The system of claim 17, wherein the microscopy device is a Confocal Laser Endo-microscopy device.

19. The system of claim 17, wherein the microscopy device is a Digital Holographic Microscopy device.

20. (canceled)

21. The system of claim 17, wherein the cellular classification process further comprises:
calculating an entropy value for each input images included in the set of input images, each entropy value representative of an amount of texture information in a respective image;
identifying one or more low-entropy images in the set of input images, wherein the one or more low-entropy images are each associated with a respective entropy value below a threshold value; and
removing the one or more low-entropy images from the set of input images prior to using the convolution sparse coding process to generate the plurality of feature maps.

22. The system of claim 17, wherein the local contrast normalization comprises applying a local subtractive operation and a divisive operation to each of the plurality of feature maps.
